(19) United States
(12) Patent Application Publication
(10) Pub. No.: US 2011/0225202 A1
(43) Pub. Date: Sep. 15, 2011

(54) MULTI-DIMENSIONAL ACCESS CONTROL LIST

(75) Inventors: Kwai Hing Man, Fremont, CA (US); Wai Kei So, Daly City, CA (US)

(73) Assignee: INTERNATIONAL BUSINESS MACHINES CORPORATION, Armonk, NY (US)

(21) Appl. No.: 13/113,750

(22) Filed: May 23, 2011

Related U.S. Application Data
(63) Continuation-in-part of application No. 11/842,314, filed on Aug. 21, 2007, now abandoned.

(51) Int. Cl. G06F 17/30

(52) U.S. Cl. 707/785; 707/E17.005

(57) ABSTRACT

Methods and apparatus, including computer program products, implementing and using techniques for providing a dynamic access control list for an object in a computer- implemented content management system. A list of one or more subjects is received. Each of the subjects is associated with a set of operations that the subject has permission to perform on the object in accordance with a first rule-set. A set of dynamic evolution conditions is defined. The dynamic evolution conditions specify under what circumstances to evolve the access control list to a new state in which a second rule-set describes a different set of operations to be associated with one or more of the subjects. The dynamic evolution conditions, the subjects, and the operations are stored in a dynamic access control list on a server in the content management system. A content management system is also described.

### CROSS-REFERENCE TO RELATED APPLICATIONS

This application is a continuation-in-part of prior application No. 11/842,314, filed on August 21, 2007, and entitled “Multi-dimensional access control list.”

### BACKGROUND

This invention generally relates to the field of computer security. Access control is an important component in maintaining computer security. One component of the access control in a computer system is an Access Control List (ACL). The ACL specifies the entities that can perform actions in the system, typically referred to as subjects, and the entities representing resources to which access may need to be controlled, typically referred to as objects. The subjects and objects are typically both considered as software entities, rather than as human users, as a human user can only have an effect on the computer system through the software entities that they control.

In a conventional ACL, each entry in the list specifies a subject and an operation, for example, the entry (Alice, delete) on the ACL for file XYZ gives a user Alice permission to delete the file XYZ. When the subject (e.g., Alice) requests to perform an operation on an object (e.g., delete file XYZ), the system first checks the list for an applicable entry in order to decide whether or not to proceed with the operation, and then proceeds in accordance with the ACL entry.

Often, however, there are situations in which the access rights ought to evolve based on factors that are not related to particular users. Currently there is no way to make ACLs adaptive. Instead, separate ACLs must be created. This is both error prone and makes the computer system with many ACLs defined is difficult to manage and maintain for the system administrators. Thus, there is a need for improved ACL mechanisms.

### SUMMARY

In general, in one aspect, the invention provides methods and apparatus, including computer program products, implementing and using techniques for providing a dynamic access control list for an object in a computer-implemented content management system. A list of one or more subjects is received. Each of the subjects is associated with a set of operations that the subject has permission to perform on the object in accordance with a first rule-set. A set of dynamic evolution conditions is defined. The dynamic evolution conditions specify under what circumstances to evolve the access control list to a new state in which a second rule-set describes a different set of operations to be associated with one or more of the subjects. The dynamic evolution conditions, the subjects, and the operations are stored in a dynamic access control list on a server in the content management system.

In general, in another aspect, the invention provides a computer-implemented content management system. The content management system includes a storage device that stores one or more objects. At least one of the objects has an associated dynamic access control list. The content management system further includes a server storing at least one dynamic access control list associated with an object among the one or more objects in the storage device. The dynamic access control list includes a list of one or more subjects, where each of the subjects is associated with a first set of operations that the subject can perform on the object in accordance with a first rule set. The dynamic access control list further includes a set of dynamic evolution conditions. The dynamic evolution conditions specify under what circumstances to evolve the dynamic access control list to a new state in which a second rule-set describes a second set of operations that the subject can perform on the object in accordance with a second rule set

The invention can be implemented to include one or more of the following advantages. In contrast to using multiple ACLs, where each ACL has a dedicated purpose, a single ACL can be used for many purposes and adapt to changing conditions. This reduces the risk for errors and makes the computer system easy to manage and maintain, thereby lowering the associated administration cost. Troubleshooting operations are also significantly simplified compared to conventional systems.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic view of a content management system (100) in accordance with one embodiment of the invention.

FIG. 2 shows a document and an associated ACL evolving over a work process, in accordance with one embodiment of the invention.

Like reference symbols in the various drawings indicate like elements.

### DETAILED DESCRIPTION

The various embodiments of the invention relate to improvements over conventional ACLs associated with content management systems. In particular, fields are added to the ACL, which specify conditions for when the ACL should evolve. These extra conditions are thus additional dimensions that the ACL must consider. This allows a single ACL to be used for many purposes and to adapt to changing conditions.

Embodiments of the invention will now be described by way of example of a simple work process associated with a content management system. The work process described herein involves only a few work nodes, privileges, and people. It should however be realized that in a real life scenario, this process can be extended to much more complex work processes and involve many more privileges and people, as is typical in conventional work processes within corporations and other organizations.

Just like conventional ACLs, the ACLs in accordance with the various embodiments of this invention are initially set up by a computer system administrator. Here, however, the administrator may not only set up static ACLs, as is currently the case, but can also define dynamic conditions that causes the ACL to evolve. For example, a user may have read privileges for a month, and after the month has passed, the user may get both read and write privileges. In three months, the user may also get edit privileges, and in four months, he may obtain delete privileges. This is one example of how an ACL can evolve based on time. As will be seen below, the ACL can also evolve based on factors other than time, for example, if person gets promoted from manager to vice president, then the ACL privileges may change.

In some embodiments, the ACL “evolution conditions” are part of the ACL itself. In other embodiments, the ACL can reference information outside the ACL, where the conditions are specified. For example, if a multi-dimensional ACL in accordance with one embodiment of the invention is a collection of conditions (month of year, for example), then for each month, an external regular ACL can be referenced. Alternatively, if the multi-dimensional ACL is implemented as a collection of conventional ACLs, then the multi-dimensional ACL can point to external conditions (e.g., month). The ACL knows when to evolve based on various mechanisms, such as polling, or through a trigger that gets invoked when a certain system administrator defined condition is fulfilled, such as a retrieve or import operation, and so on.

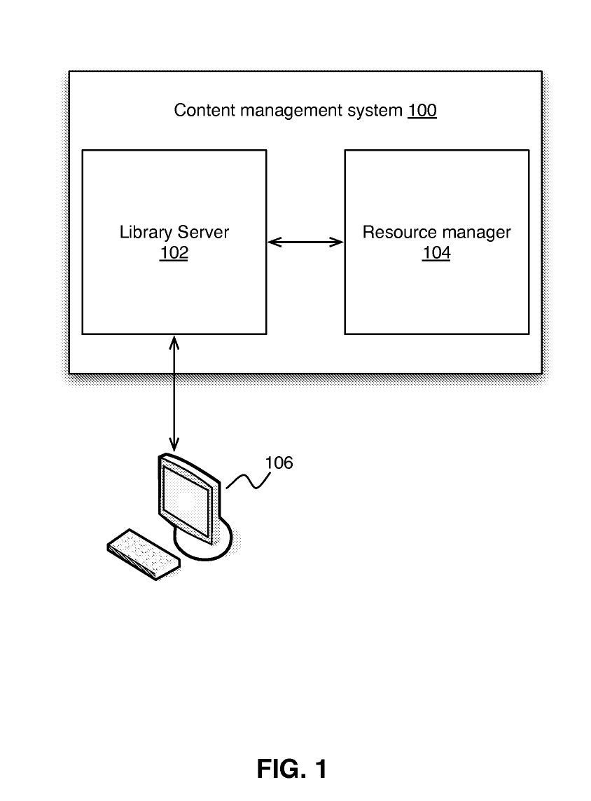

FIG. 1 shows a schematic view of a content management system (100) in accordance with one embodiment. As can be seen in FIG. 1, the content management system (100) includes a library server (102) and a resource manager (104). The primary purpose of the library server (102) is to service requests from a client (106) for content. The content itself is stored in the resource manager (104). Typically, there is only one library server (102) in a content management system (100), but there may be more than one resource manager (104) linked to the library server (102).

In order to control the access to the content on the resource manager (104), the library server (102) stores the single ACL, similar to how conventional ACLs are stored in conventional library servers. Expressed differently, the library server contains the definitions of what the content management system (100) is capable of doing. Whenever a client (106) attempts to perform an operation on an object stored in the resource manager (104), the content management system (100) checks with the library server (102) whether the proposed operation is allowed by the ACL. If the operation is permitted, then it is carried out. Otherwise the operation is denied and (optionally) an error message is sent to the client (106).

The content stored in the resource manager (104) can be digital objects of essentially any type. Some examples include scanned documents, word processing documents, digital photos, emails, audio conversations, etc. Typically, digital objects that are similar in some sense are grouped into item types. This enables a system administrator to set up access rules for the various item types rather than the individual digital objects that are contained in each grouping. The grouping into item types can be done based on a number of factors, such as the type of content, the purpose of the content, the type of customer to which the content relates, the users that may access the content, the department in an organization to which the content belongs, etc.

User access to the content management system (100) can be implemented by a system administrator on multiple levels. For example, the system administrator can define:
Users who are allowed to use the system, typically through a login name and password authentication.
User groups that each define a set of users with common access control, for example, “Directors,” “Managers,” “Finance Department,” and so on.
Privileges that allow a user to access objects in a specific way (i.e., to perform a specific action on the objects), such as “read,” “write,” “modify,” etc.
ACLs, which are lists of users or user groups and their associated privileges.

As was described above, the ACLs on the library server (102) protects the access to the objects on the resource manager (104). Typically, the content management system (100) uses both the ACLs and the privileges associated with a user to check if a user may perform an action on an object. First, the content management system (100) checks if the user has the privilege to perform the specific action, and then it checks if the ACL associated with the user allows the user to access the specific object. Both conditions must be satisfied. The ACL may specify conditions based on a variety of factors, such as objects or documents stored in the resource manager (104), item types (such as folders), work nodes, or workflow processes, just to mention a few factors. As used herein, a workflow process is a series of steps that a digital object passes through. The workflow process typically includes a number of work nodes. Each work node represents a physical step where an action is being performed by a user or an application.

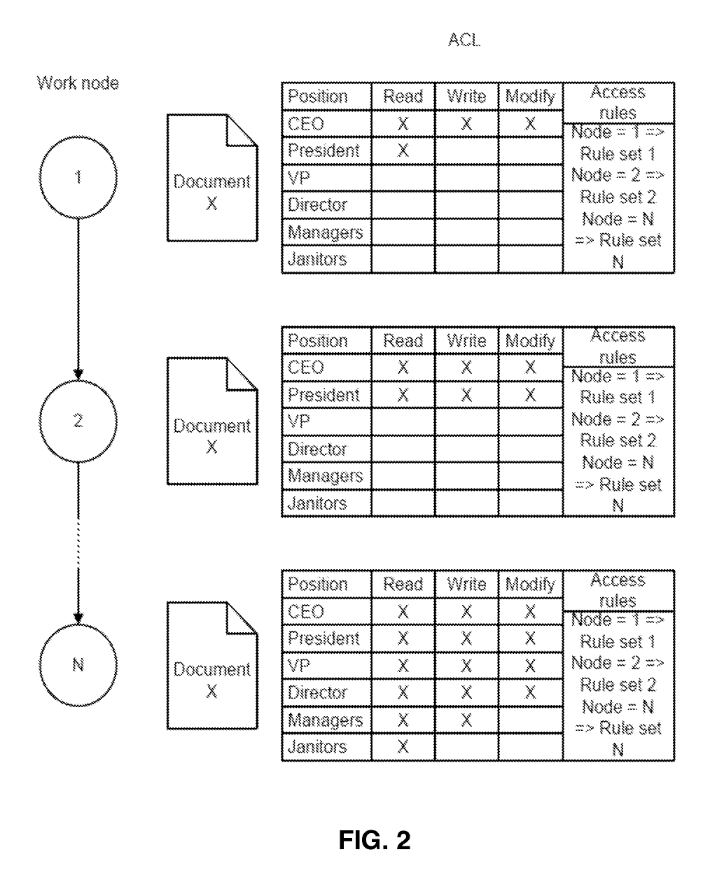

As was discussed above, the ACLs in accordance with the various embodiments of the invention include access rules that specify under what conditions the ACL should evolve, that is, under what conditions should the ACL change such that a different set of rules is applied. This will now be illustrated by way of example with reference to FIG. 2.

FIG. 2 shows a Document X passing through a workflow process that has N work nodes, labeled 1, 2. . . N. Document X is stored in the resource manager (104) of the content management system (100) and has an associated ACL on the library server (102), which defines the operations (i.e. privileges) people in various positions (i.e., user groups) can perform on Document X at each work node. A set of Access Rules in the ACL specifies what rules should apply under what conditions, for example, in the different work nodes. That is, the access rules specify how the ACL should evolve as Document X moves through the work nodes of the workflow process. As shown in FIG. 2, the ACL specifies that a “Rule set 1” should be applied in work node 1, a “Rule set 2” should be applied in work node 2, and a “Rule set N” should be applied in work node N. In the implementation shown in FIG. 2, the ACL contains three types of operations (read, write and modify) for the following groups of people: CEO, President, Vice President, Director, Managers, and Janitors. At each stage of the work flow process, the various types of access to Document X are reviewed and either rejected or approved for the different groups of people.

Suppose the CEO initiates Document X in a work process that details an acquisition of a rival company. At Node 1, because it is still early in the potential acquisition, such information should only be disclosed to the CEO and to the president. As such, the ACL for Document X (not the ACL for work node 1) will be used to filter out all access by anyone else in accordance with “Rule Set 1”, and give the CEO read, write and modify access and give the President read access, as indicated in the ACL. Once approved, Document X proceeds to Node 2, at which “Rule Set 2” is in effect and where the CEO retains the same privileges as in Node 1, and the President is also granted write and modify access. At each subsequent stage of the workflow process, the ACL allows more and more people access, as illustrated in FIG. 2 by work node N and “Rule Set N”, as the proposal outlined in Document X is becoming more realistic, and thus can be publicized.

As can be seen in the above example, in this case, a set of privileges is associated with a particular group of people. For each privilege, a condition can be assigned. If that condition is met, the privilege can be enabled or disabled. In the above case with the acquisition process, the condition is the current stage of the acquisition process, or in more general terms, the respective work nodes of a workflow process. That is, different level of access is granted to different people during different stages of the acquisition process.

Furthermore, it is important to note that in the above example, there is only a single ACL throughout all the work nodes, unlike current implementations, in which a separate ACL is needed for each work node. This distinction is important, as in a conventional computer system the number of work nodes (and thus the number of ACLs) grows to be extremely large. With the design in accordance with the embodiments described herein, only one ACL will be necessary.

In the above example, the ACL evolved based on the work nodes in the workflow process, but more generally speaking, the ACL can evolve based on a variety of factors. For example, the ACL in a content management system (100) can evolve based on:

The device in which a digital object is stored: For example, if a document is stored in a fast device, then everyone can access it, whereas if the document is stored on a slow device (e.g., on tape), then only managers or administrators can access the document.

Migration steps in a migration policy: For example, after a first migration, user A may access the document. After a second migration, user A and user B may access the document.

Storage capacity of a resource manager: For example, only a manager or system administrator may be able to create or update a document in a resource manager that only has 10% of its storage space available.

Version of the digital object: For example, there may be three versions of a same document. All users may be able to access version 3, which is the current version, whereas managers can access versions 2 and 3, and a system administrator can access all versions of the document.

Many other types of evolution conditions for ACLs can be envisioned and implemented by those of ordinary skill in the art and within the scope of the appended claims. With this ability to adapt, ACLs become much easier to manage and use compared to the plethora of ACLs in conventional content management systems.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, or store the program for use by or in connection with the instruction execution system, apparatus, or device.

The medium can be an electronic, magnetic, optical, electromagnetic, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

A number of implementations of the invention have been described. Nevertheless, it will be understood that various modifications may be made without departing from the spirit and scope of the invention. For example, the various embodiments of the invention have been described above with reference to accessing documents in a computer system. However, it should be clear that the same principles can be applied within other areas as well. For example, the ACLs can be implemented in car keys, which are primarily electronic these days, and only allow unlocking of the doors to the car and starting of the engine if certain conditions are fulfilled, e.g., depending on the sobriety of the driver, the time of day, and so on. Accordingly, other embodiments are within the scope of the following claims.

1. A computer-implemented content management system, comprising:
a storage device operable to store one or more objects, wherein at least one of the objects has an associated dynamic access control list;
a server storing at least one dynamic access control list associated with an object among the one or more objects in the storage device, the dynamic access control list including:
a list of one or more subjects, each of the subjects being associated with a first set of operations that the subject can perform on the object in accordance with a first rule set; and
a set of dynamic evolution conditions, the dynamic evolution conditions specifying under what circumstances to evolve the dynamic access control list to a new state in which a second rule-set describes a second set of operations that the subject can perform on the object in accordance with a second rule set.

2. The content management system of claim 1, wherein the one or more subjects include one or more user profiles defined in the content management system.

3. The content management system of claim 1, wherein a single dynamic access control list is associated with each object in the content management system at any given time.

4. The content management system of claim 1, wherein the object is a computer file representing a document, and the operations include one or more of: create privileges, read privileges, write privileges, modify privileges and delete privileges for the document.

5. The content management system of claim 1, wherein the dynamic evolution conditions are related to one or more of: the type of objects stored in the storage device, work nodes associated with the objects, workflow processes associated with the objects, properties of the storage device in which the objects are stored, and migration steps in a migration policy for the objects.

6. A method performed by a computer for providing a dynamic access control list for an object in a computer-implemented content management system, the method comprising:
receiving a list of one or more subjects;
associating, by a processor in the content management system, each of the subjects with a set of operations that the subject has permission to perform on the object in accordance with a first rule-set;
defining, by the processor, a set of dynamic evolution conditions, the dynamic evolution conditions specifying under what circumstances to evolve the access control list to a new state in which a second rule-set describes a different set of operations to be associated with one or more of the subjects; and
storing, by the processor, the dynamic evolution conditions, the subjects, and the operations in a dynamic access control list on a server in the content management system.

7. The method of claim 6, wherein the one or more subjects include one or more user profiles defined in the content management system.

8. The method of claim 6, wherein only a single dynamic access control list is associated with each object in the content management system at any given time.

9. The method of claim 6, wherein the object is a computer file representing a document, and the operations include one or more of: create privileges, read privileges, write privileges, modify privileges and delete privileges for the document.

10. The method of claim 6, wherein the dynamic evolution conditions are related to one or more of: the type of objects stored in the storage device, work nodes associated with the objects, workflow processes associated with the objects, properties of the storage device in which the objects are stored, and migration steps in a migration policy for the objects.

11. A computer program product for providing a dynamic access control list for an object in a computer-implemented content management system, the computer program product comprising:
a computer readable storage medium having computer readable program code embodied therewith, the computer readable program code comprising:
computer readable program code configured to receive a list of one or more subjects;
computer readable program code configured to associate each of the subjects with a set of operations that the subject has permission to perform on the object in accordance with a first rule-set;
computer readable program code configured to define a set of dynamic evolution conditions, the dynamic evolution conditions specifying under what circumstances to evolve the access control list to a new state in which a second rule-set describes a different set of operations to be associated with one or more of the subjects; and
computer readable program code configured to store the dynamic evolution conditions, the subjects, and the operations in a dynamic access control list on a server in the content management system.

12. The computer program product of claim 11, wherein the one or more subjects include one or more user profiles defined in the content management system.

13. The computer program product of claim 11, wherein only a single dynamic access control list is associated with each object in the content management system at any given time.

14. The computer program product of claim 11, wherein the object is a computer file representing a document, and the operations include one or more of: create privileges, read privileges, write privileges, modify privileges and delete privileges for the document.

15. The computer program product of claim 11, wherein the dynamic evolution conditions are related to one or more of: the type of objects stored in the storage device, work nodes associated with the objects, workflow processes associated with the objects, properties of the storage device in which the objects are stored, and migration steps in a migration policy for the objects.
